(19) United States
(12) Patent Application Publication
(10) Pub. No.: US 2026/0006654 A1
(43) Pub. Date: Jan. 1, 2026

(54) METHODS AND SYSTEMS FOR MANAGING BEACON FRAME

(71) Applicant: Samsung Electronics Co., Ltd., Suwon-si (KR)

(72) Inventors: Manasi EKKUNDI, Bangalore (IN); Karthik Srinivasa GOPALAN, Bangalore (IN); Abhishek CHATURVEDI, Bangalore (IN)

(21) Appl. No.: 19/295,258

(22) Filed: Aug. 8, 2025

Related U.S. Application Data
(63) Continuation of application No. PCT/KR2025/009085, filed on Jun. 27, 2025.

(30) Foreign Application Priority Data
Jul. 1, 2024 (IN) 202441050365
Jun. 11, 2025 (IN) 202441050365

(51) Int. Cl. H04W 76/11

(52) U.S. Cl. CPC H04W 76/11

(57) ABSTRACT

The present disclosure provides techniques for managing a beacon frame. The method includes transmitting, by an Access Point (AP), the beacon frame to one or more devices. The beacon frame includes at least one of a short indicator for indicating support of Ultra High Reliability (UHR) capabilities, a short version information of the UHR capabilities, and periodic transmission information of the UHR capabilities. The method further includes receiving, by the AP, one or more first UHR capabilities associated with at least one UHR capable device among the one or more devices in response to transmitting the beacon frame.

### CROSS-REFERENCE TO RELATED APPLICATIONS

This application is a continuation of International Application No. PCT/KR2025/009085 designating the United States, filed on Jun. 27, 2025, in the Korean Intellectual Property Receiving Office and claiming priority to Indian Provisional Patent Application No. 202441050365, filed on Jul. 1, 2024, and Indian Complete Patent Application No. 202441050365, filed on Jun. 11, 2025, in the Indian Patent Office, the disclosures of each of which are incorporated by reference herein in their entireties.

### BACKGROUND

### Field

The disclosure relates to wireless communication, and for example, relates to systems and methods for managing a beacon frame in a Wireless Fidelity (Wi-Fi) network.

### Description of Related Art

Wireless local area networks (WLANs) based on Institute of Electrical and Electronics Engineers (IEEE) 802.11 standards are commonly referred to as Wireless Fidelity (Wi-Fi) networks. The Wi-Fi networks are deployed in residential, commercial, public, and industrial environments. The Wi-Fi networks support a wide range of devices, including smartphones, laptops, tablets, Access Points (APs), smart home appliances, industrial sensors, and other Internet of Things (IoT) endpoints. The IEEE 802.11 standard has undergone continuous evolution, introducing successive generations such as Wi-Fi 4 (802.11n), Wi-Fi 5 (802.11ac), Wi-Fi 6/6E (802.11ax), Wi-Fi 7 (802.11be), and the emerging Wi-Fi 8 (802.11bn). Each new generation enhances data throughput, efficiency, spectrum utilization, and user experience while maintaining backward compatibility with legacy devices.

A critical component of Wi-Fi communication is a beacon frame. In IEEE 802.11-based networks, the beacon frames are periodically transmitted by the AP to advertise the presence and capabilities of the wireless network. The beacon frames are a type of management frame typically broadcast every 100 milliseconds. The beacon frames are used by user devices to discover, join, and synchronize with the wireless network. The beacon frames play a vital role in the wireless network operation by enabling the user devices to discover and synchronize with APs. FIG. 1 illustrates a frame structure 100 depicting mandatory and optional fields of a beacon frame, in accordance with related art. As shown, the beacon frame includes mandatory fields 101 and optional fields 103. The mandatory fields commonly include a timestamp, beacon interval, capability information, Service Set Identifier (SSID), and supported data rates. The optional fields are encapsulated as Information Elements (IEs) and convey additional capabilities and configuration parameters supported by the AP. The IEs help maintain backward compatibility with the user devices that conform to earlier Wi-Fi standards while also supporting newer features introduced in recent specifications. For example, a Wi-Fi 8-capable AP may advertise support for prior generations, including Wi-Fi 4, 5, 6, 6E, and 7. Consequently, the beacon frame may contain IEs related to High Throughput (HT), Very High Throughput (VHT), High Efficiency (HE), Extended High Throughput (EHT), and other emerging capabilities.

Wi-Fi 7 network (802.11be) introduces a key enhancement in the Wi-Fi network, e.g., Multi-Link Operation (MLO). The MLO improves aggregate throughput, reduces latency, and enhances overall reliability. To support MLO capability, the structure of the beacon frame has been extended to include both link-specific and common control information applicable across multiple radio interfaces. For example, FIG. 2 illustrates IEs added in the beacon frame for supporting MLO in the Wi-Fi 7 network, in accordance with related art. As illustrated in FIG. 2, the extended beacon frame includes new IEs such as the Multi-Link Element, Multi-Link Traffic Indication, and Traffic Identifier (TID)-to-Link Mapping. Each of these elements forms part of the optional fields defined for multi-link operation in the Wi-Fi 7 standard.

Despite the enhanced feature set, the extended beacon frame structure introduces significant operational challenges. The continuous addition of new IEs corresponding to evolving Wi-Fi specifications has resulted in substantial growth in beacon frame size. For example, the beacon frames in Wi-Fi 7 often exceed 500 bytes. Further, due to the requirement for backward compatibility, beacon transmissions must still occur over the 20 MHz primary channel and use low data rates that are decodable by legacy user devices. The resulting increase in transmission time contributes to elevated airtime consumption, reduced spectral efficiency, and potential delays in congested environments. Such a scenario is depicted in FIG. 3. FIG. 3 illustrates a structure of the beacon frame for different Wi-Fi standards, in accordance with related art. As shown in FIG. 3, each successive Wi-Fi specification introduces new functional elements and corresponding configuration fields that must be embedded in the beacon. The cumulative inclusion of feature-related IEs, such as those introduced in Wi-Fi 7 and anticipated additions from the upcoming IEEE 802.11bn standard, leads to further enlargement of the beacon frame. Increased frame size directly translates to greater transmission airtime, particularly because the beacon continues to use only the primary 20 MHz channel and must be transmitted at the lowest mandatory rates for compatibility purposes.

Another limitation arises from the static and inclusive nature of beacon transmission. The beacon frames are periodically broadcast, typically every 100 milliseconds. Further, the beacon frames must encapsulate all configuration and capability information of the AP regardless of the presence or absence of the user devices that support those features within a Basic Service Set (BSS). Such a scenario is depicted in FIG. 4. FIG. 4 illustrates a network environment 400 comprising multiple user devices of different Wi-Fi standards, in accordance with related art. As illustrated in FIG. 4, an AP 401 is connected to various user devices, such as a Television (TV) 403, a fridge 405, a laptop 407, a security camera 409, and a light bulb 411. However, none of these user devices support Wi-Fi 8 standards. However, the AP 401 is still obligated to transmit beacon frames containing the full set of Wi-Fi 8-related IEs if the legacy design of beacons is allowed in 802.11bn specification. Accordingly, the AP unnecessarily includes IEs associated with advanced capabilities not supported by any user device in the BSS. Such a configuration of the beacon frames results in inefficient airtime utilization, elevated transmission overhead, and increased power consumption at the AP, without delivering any functional benefit to the current network environment.

Furthermore, the restriction requiring beacon transmissions to occur exclusively on the 20 MHz primary channel presents additional performance challenges. In high-density or congested environments, heavy traffic on the primary channel can cause delays in beacon delivery, which adversely affects synchronization, network discovery, and overall stability. The combination of beacon size growth, mandatory low-rate transmission, and static content packaging leads to degraded efficiency in modern wireless deployments. Further, such a combination also presents obstacles to scalable, high-performance network operation.

The description set forth in the background section should not be assumed to be prior art merely because it is set forth in the background section. The background section may describe aspects or an embodiment.

### SUMMARY

One aspect of the present disclosure provides a user device associated with an access point (AP). The user device comprises at least one processor including processing circuitry. The user device comprises memory storing instructions that, when executed by the at least one processor individually or collectively, cause the user device to receive a beacon frame from the AP, wherein the beacon frame includes one or more of a short indicator for indicating support of Ultra High Reliability (UHR) capabilities, a short information of the UHR capabilities, and periodic transmission information of the UHR capabilities. The instructions, when executed by the at least one processor individually or collectively, cause the user device to transmit one or more first UHR capabilities associated with the user device in response to receiving the beacon frame.

In an embodiment, based on the beacon frame including the short indicator of the UHR capabilities, the instructions, when executed by the at least one processor individually or collectively, cause the user device to transmit a request frame to the AP, the request frame comprising a request for receiving one or more second UHR capabilities associated with the AP. The instructions, when executed by the at least one processor individually or collectively, cause the user device to receive, from the AP, the one or more second UHR capabilities.

In an embodiment, the transmitting of the request comprises transmitting the request in a capability request frame.

In an embodiment, the instructions, when executed by the at least one processor individually or collectively, cause the user device to receive, from the AP, the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

In an embodiment, the short indicator includes a one bit indicator set to 1 indicating support for the UHR capabilities.

In an embodiment, based on the beacon frame including the periodic transmission information of the UHR capabilities, the instructions, when executed by the at least one processor individually or collectively, cause the user device to receive, from the AP, information associated with dynamic periodic time interval for transmitting the one or more second UHR capabilities in a Beacon UHR frame.

In an embodiment, the instructions, when executed by the at least one processor individually or collectively, cause the user device to transmit, to the AP, an addition request indicating an identification information of a target AP. The instructions, when executed by the at least one processor individually or collectively, cause the user device to transmit, to the AP, one or more third UHR capabilities associated with the target AP. The instructions, when executed by the at least one processor individually or collectively, cause the user device to receive, from the AP, the one or more third UHR capabilities associated with the target AP.

In an embodiment, the user device includes a Non-UHR capable user device, wherein the Non-UHR capable user device is configured to ignore at least one of the short indicator, the short information, and the periodic transmission information in the beacon frame.

One aspect of the present disclosure provides a method of wireless communication performed by a user device associated with an access point (AP). The method comprises receiving a beacon frame from the AP, wherein the beacon frame includes one or more of a short indicator for indicating support of Ultra High Reliability (UHR) capabilities, a short information of the UHR capabilities, and periodic transmission information of the UHR capabilities. The method comprises transmitting one or more first UHR capabilities associated with the user device in response to receiving the beacon frame.

In an embodiment, based on the beacon frame including the short indicator of the UHR capabilities, the method comprises: transmitting, to the AP, a request frame comprising a request for receiving one or more second UHR capabilities associated with the AP, and receiving, from the AP, the one or more second UHR capabilities.

In an embodiment, the transmitting of the request comprises transmitting the request in a capability request frame.

In an embodiment, the method comprises receiving, from the AP, the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

In an embodiment, the short indicator includes a one bit indicator set to 1 indicating support for the UHR capabilities.

In an embodiment, wherein based on the beacon frame including the periodic transmission information of the UHR capabilities, the method comprises receiving, from the AP, information associated with dynamic periodic time interval for transmitting the one or more second UHR capabilities in a Beacon UHR frame.

In an embodiment, the method comprises transmitting, to the AP, an addition request indicating an identification information of a target AP. The method comprises transmitting, to the AP, one or more third UHR capabilities associated with the target AP. The method comprises receiving, from the AP, the one or more third UHR capabilities associated with the target AP.

In an embodiment, the user device includes a Non-UHR capable user device, wherein the Non-UHR capable user device is configured to ignore at least one of the short indicator, the short information, and the periodic transmission information in the beacon frame.

One aspect of the present disclosure provides an access point (AP). The user device comprises at least one processor including processing circuitry. The AP comprises memory storing instructions that, when executed by the at least one processor individually or collectively, cause the AP to transmit the beacon frame to one or more user devices connected with the AP, wherein the beacon frame includes at least one of a short indicator indicating support of Ultra High Reliability (UHR) capabilities, a short information of the UHR capabilities, and periodic transmission information of the UHR capabilities. The instructions, when executed by the at least one processor individually or collectively, cause the AP to receive one or more first UHR capabilities associated with at least one UHR capable user device among the one or more user devices in response to transmission of the beacon frame.

In an embodiment, based on the beacon frame including the short indicator of the UHR capabilities, the instructions that, when executed by the at least one processor individually or collectively, cause the AP to: receive a request frame comprising a request for receiving one or more second UHR capabilities associated with the AP, and transmit the one or more second UHR capabilities to the at least one UHR capable user device via a Response frame.

In an embodiment, the instructions that, when executed by the at least one processor individually or collectively, cause the AP to receive the request in a capability request frame.

In an embodiment, upon reception of the request, the instructions that, when executed by the at least one processor individually or collectively, cause the AP to: transmit the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

In an embodiment, the short indicator includes a one bit indicator set to 1 to indicate support for the UHR capabilities.

In an embodiment, based on the beacon frame including the periodic transmission information of the UHR capabilities, the instructions that, when executed by the at least one processor individually or collectively, cause the AP to transmit information associated with dynamic periodic time interval for transmitting the one or more second UHR capabilities in a Beacon UHR frame.

In an embodiment, based on the beacon frame including the short information, the instructions that, when executed by the at least one processor individually or collectively, cause the AP to: include a link information in the beacon frame for transmitting the one or more second UHR capabilities using a specified communication link between the AP and the at least one UHR capable user device, wherein the specified communication link is different than a communication link used for transmitting the beacon frame.

In an embodiment, based on the beacon frame including the short indicator, the instructions that, when executed by the at least one processor individually or collectively, cause the AP to include a non-primary channel information in the beacon frame for transmitting the one or more second UHR capabilities.

In an embodiment, based on the beacon frame including the short information, the instructions that, when executed by the at least one processor individually or collectively, cause the AP to include a version information of the one or more second UHR capabilities in the beacon frame to identify updates of the one or more second UHR capabilities.

In an embodiment, the instructions that, when executed by the at least one processor individually or collectively, cause the AP to receive, from the at least one UHR capable user device, an additional request indicating an identification information of a target AP. The instructions that, when executed by the at least one processor individually or collectively, cause the AP to receive, from the target AP, one or more third UHR capabilities associated with the target AP. The instructions that, when executed by the at least one processor individually or collectively, cause the AP to transmit, to the at least one UHR capable user device, the one or more third UHR capabilities associated with the target AP.

In an embodiment, the instructions that, when executed by the at least one processor individually or collectively, cause the AP to transmit the one or more second UHR capabilities in the beacon frame upon receiving a request from a number of specified UHR capable user devices.

In an embodiment, the instructions that, when executed by the at least one processor individually or collectively, cause the AP to identify a specified set of UHR capable user devices among the one or more user devices in a Basic Serving Set (BSS) associated with the AP. The instructions that, when executed by the at least one processor individually or collectively, cause the AP to include the one or more second UHR capabilities in a specified beacon frame to support the one or more UHR capable user devices among the specified set of UHR capable user devices upon identification.

One aspect of the present disclosure provides a method of wireless communication performed by an access point (AP). The method comprises transmitting the beacon frame to one or more user devices, wherein the beacon frame includes at least one of a short indicator for indicating support of Ultra High Reliability (UHR) capabilities, a short information of the UHR capabilities, and periodic transmission information of the UHR capabilities. The method comprises receiving one or more first UHR capabilities associated with at least one UHR capable user device among the one or more user devices in response to transmitting the beacon frame.

In an embodiment, based on the beacon frame including the short indicator of the UHR capabilities, the method comprises receiving a request frame comprising a request for receiving one or more second UHR capabilities associated with the AP, and transmitting the one or more second UHR capabilities to the at least one UHR capable user device via a Response frame.

In an embodiment, receiving the request comprises receiving the request in a capability request frame.

In an embodiment, upon receiving the request, the method (1700) comprises transmitting the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

In an embodiment, the short indicator includes a one bit indicator set to 1 indicating support for the UHR capabilities.

In an embodiment, based on the beacon frame including the periodic transmission information of the UHR capabilities, the method comprises transmitting information associated with dynamic periodic time interval for transmitting the one or more second UHR capabilities in a Beacon UHR frame.

In an embodiment, based on the beacon frame including the short information, the method comprises including a link information in the beacon frame for transmitting the one or more second UHR capabilities using a specified communication link between the AP and the at least one UHR capable user device, wherein the specified communication link is different than a communication link used for transmitting the beacon frame.

In an embodiment, based on the beacon frame including the short indicator, the method comprises including a non-primary channel information in the beacon frame for transmitting the one or more second UHR capabilities.

In an embodiment, based on the beacon frame including the short information, the method comprises including a version information of the one or more second UHR capabilities in the beacon frame to identify updates of the one or more second UHR capabilities.

In an embodiment, the method comprises receiving, from the at least one UHR capable user device, an addition request indicating an identification information of a target AP. The method comprises receiving, from the target AP, one or more third UHR capabilities associated with the target AP. The method comprises transmitting, to the at least one UHR capable user device, the one or more third UHR capabilities associated with the target AP.

In an embodiment, the method comprises transmitting the one or more second UHR capabilities in the beacon frame upon receiving a request from a number of specified UHR capable user devices.

In an embodiment, the method comprises identifying a specified set of UHR capable user devices among the one or more user devices in a Basic Serving Set (BSS) associated with the AP. The method comprises including the one or more second UHR capabilities in a specified beacon frame to support the one or more UHR capable user devices among the specified set of UHR capable user devices upon identification.

In an embodiment, the one or more user devices include at least one Non-UHR capable user device, wherein the at least one Non-UHR capable user device is configured to ignore at least one of the short indicator, the short information, and the periodic transmission information in the beacon frame.

One aspect of the present disclosure provides a non-transitory computer-readable storage medium. The methods disclosed herein can be performed by one or more computer programs stored on the non-transitory computer-readable storage medium.

One aspect of the present disclosure provides a non-transitory computer-readable storage medium storing one or more computer programs. The one or more computer programs, when executed by at least one processor individually or collectively, cause a user device associated with an access point (AP) to perform a method of wireless communication. The method comprises receiving a beacon frame from the AP, wherein the beacon frame includes one or more of a short indicator for indicating support of Ultra High Reliability (UHR) capabilities, a short information of the UHR capabilities, and periodic transmission information of the UHR capabilities. The method comprises transmitting one or more first UHR capabilities associated with the user device in response to receiving the beacon frame.

One aspect of the present disclosure provides a non-transitory computer-readable storage medium storing one or more computer programs. The one or more computer programs, when executed by at least one processor individually or collectively, cause an access point (AP) to perform a method of wireless communication. The method comprises transmitting the beacon frame to one or more user devices, wherein the beacon frame includes at least one of a short indicator for indicating support of Ultra High Reliability (UHR) capabilities, a short information of the UHR capabilities, and periodic transmission information of the UHR capabilities. The method comprises receiving one or more first UHR capabilities associated with at least one UHR capable user device among the one or more user devices in response to transmitting the beacon frame.

To further clarify the advantages and features of the present disclosure, a more particular description will be rendered with reference to various example embodiments thereof, which are illustrated in the appended drawings. It will be appreciated that these drawings depict example embodiments and are therefore not to be considered limiting its scope. The disclosure will be described and explained with additional specificity and detail with the accompanying drawings.

### BRIEF DESCRIPTION OF THE DRAWINGS

These and other features, aspects, and advantages of certain embodiments the present disclosure will be more apparent from the following detailed description, taken in conjunction with the accompanying drawings in which like characters represent like parts throughout the drawings.

FIG. 1 is a diagram illustrating a frame structure depicting mandatory and optional fields of a beacon frame, in accordance with related art.

FIG. 2 is a diagram illustrating a beacon frame structure with added Information Elements (IEs) for supporting Multi-Link Operation (MLO) in a Wireless Fidelity (Wi-Fi 7) network, in accordance with related art.

FIG. 3 is a diagram illustrating a structure of the beacon frame for different Wi-Fi standards, in accordance with related art.

FIG. 4 is a diagram illustrating a network environment comprising multiple user devices of different Wi-Fi standards, in accordance with related art.

FIG. 5 is a diagram illustrating an example Wi-Fi network that supports managing a beacon frame in the Wi-Fi network, according to an embodiment.

FIG. 6 is a block diagram illustrating an example configuration of a system for managing the beacon frame, according to an embodiment.

FIG. 7 is a diagram illustrating an example frame structure of a beacon frame indicating support for Ultra High Reliability (UHR) capabilities, according to an embodiment.

FIG. 8 is a diagram illustrating an example frame structure of the beacon frame including the short information of UHR capabilities, according to an embodiment.

FIG. 9 is a signal flow diagram illustrating example operations for transmitting one or more second UHR capabilities associated with an Access Point (AP), according to an embodiment.

FIG. 10 is a signal flow diagram illustrating example operations for transmitting the one or more second UHR capabilities associated with the AP, according to an embodiment.

FIG. 11A is a diagram illustrating an example scenario of non-utilization of a non-primary channel, in accordance with related art.

FIG. 11B is a diagram illustrating an example scenario of the utilization of a non-primary channel, according to an embodiment.

FIG. 12A is a diagram illustrating an example scenario of beacon transmissions, in accordance with related art.

FIG. 12B is a diagram illustrating an example scenario of Beacons and Beacons for UHR, according to an embodiment.

FIG. 13 is a diagram illustrating an example scenario of transmitting a beacon UHR frame in dynamic intervals, according to an embodiment.

FIG. 14 is a signal flow diagram illustrating example operations for the transmission of the one or more second UHR capabilities associated with the AP in a roaming scenario, according to an embodiment.

FIG. 15 is a diagram illustrating an example scenario for transmitting the one or more second UHR capabilities in a legacy beacon frame, according to an embodiment.

FIG. 16 is a block diagram illustrating an example configuration of a system for managing the beacon frame, according to an embodiment.

FIGS. 17 and 18 are flowcharts illustrating example methods for managing the beacon frame, according to an embodiment; and

FIGS. 19A, 19B and 19C are diagrams illustrating example use cases of implementing the beacon frame, according to an embodiment.

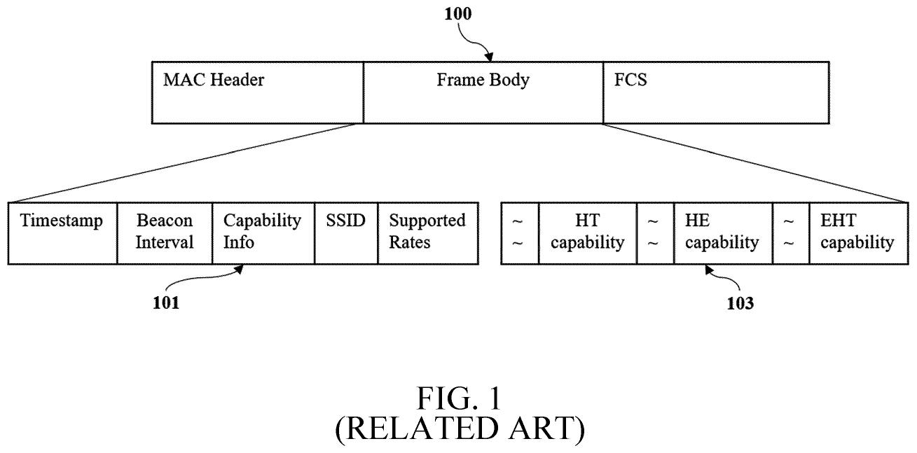

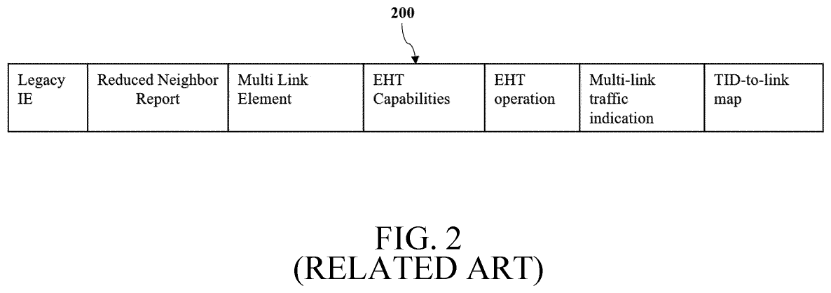

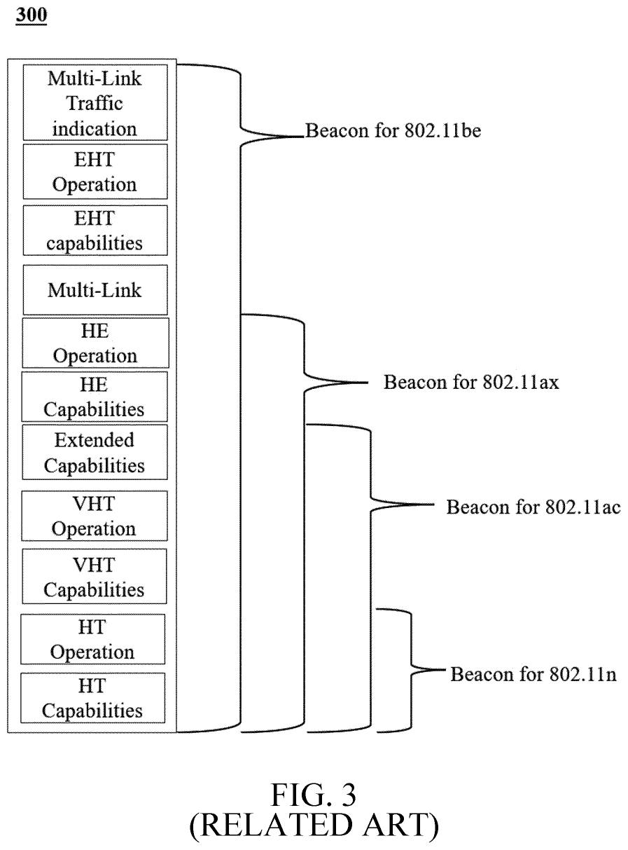

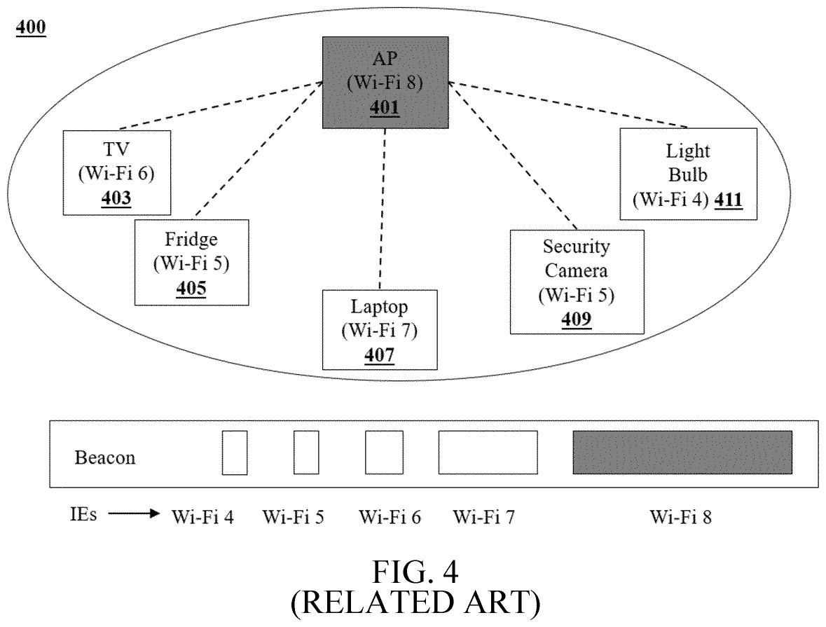

Further, skilled artisans will appreciate that those elements in the drawings are illustrated for simplicity and may not have necessarily been drawn to scale. For example, the flowcharts illustrate the method in terms of operations involved to help improve understanding of aspects of the present disclosure. Furthermore, in terms of the construction of the device, one or more components of the device may have been represented in the drawings by conventional symbols, and the drawings may show those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various example embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Various example embodiments have been described for the purpose of explaining one or more of the potential ways in which the specific features and/or elements of the disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, may refer, for example, to different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” may refer, for example, to one or more. Accordingly, the set of items may be a single item or a collection of two or more items. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

Moreover, multiple functions described below may be implemented or supported by one or more computer programs, each of which is formed from computer-readable program code and embodied in a computer-readable medium. The terms “application” and “program” may refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data may be permanently stored and media where data may be stored and later overwritten, such as a rewritable optical disc or an erasable memory device.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

The present disclosure provides techniques for defining beacon frames for Ultra High Reliability (UHR) capability in a Wi-Fi network. The UHR capability ensures stable, low-latency wireless connections for demanding applications like Augmented Reality (AR)/Virtual Reality (VR) and industrial automation. The UHR uses features like Multi-Link Operation (MLO) and improved interference handling to deliver consistent performance, even in a congested environment. In an embodiment, the disclosed techniques add an indication in a legacy beacon frame to indicate whether an Access Point (AP) supports the UHR capability. The indication uses a few bits to provide quick information about UHR support. The bit also shows whether the UHR capability has been updated. User devices are notified to acquire updated information if needed. Initially, the AP includes only the UHR support indication in the beacon frame. If multiple user devices repeatedly request UHR features, the AP can then include UHR features in subsequent beacon frames. The process continues until a significant number of UHR capable devices are detected in the Basic Service Set (BSS) of the AP.

Embodiments of the present disclosure will be described below in greater detail with reference to the accompanying drawings.

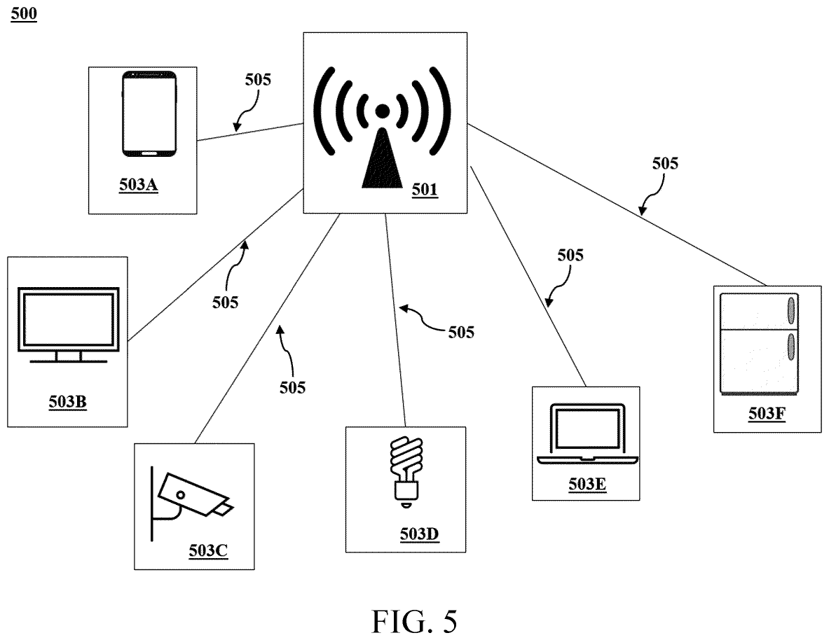

FIG. 5 is a diagram illustrating an example wireless communication network 500 that supports managing a beacon frame in the wireless communication network, according to various embodiments. In an embodiment, the wireless communication network 500 may correspond to a Wi-Fi network capable of supporting different versions of Wi-Fi, such as Wi-Fi 6, Wi-Fi 6E, Wi-Fi 7, and higher Wi-Fi networks. The wireless communication network 500 may include an Access Point (AP) 501 connected to a plurality of user devices (also referred to as the user devices 503). The AP 501 may serve as a central wireless node that facilitates network connectivity by bridging the user device 503 with a wired or core network infrastructure (not shown). The AP 501 may include, but is not limited to, transceivers, antennas, processing circuitry, and software logic to manage wireless traffic, authenticate users, and allocate radio resources. The user devices 503 may be any wireless-enabled terminals or nodes. The user devices 503 may include, but are not limited to, a smartphone 503A, a Television (TV) 503B, a security camera 503C, a smart light bulb 503D, a laptop 503E, and a smart refrigerator 503F. The user device 503 may be a station (STA) in a wireless network. Further, some of the user devices from among the user devices 503 are UHR capable user devices, such as the smartphone 503A and the laptop 503E. However, the rest of the user devices from among the user device 503 are Non-UHR capable user devices, such as the TV 503B, the security camera 503C, the smart light bulb 503D, and the smart refrigerator 503F. Each of the user devices 503 may be capable of establishing a wireless connection with the AP 501 via one or more communication links 505. The one or more communication links 505 may represent active wireless communication paths established between the AP 501 and the user devices 503. The one or more communication links 505 may operate according to one or more wireless communication standards, such as IEEE 802.11 (e.g., 802.11n, 802.11ac, 802.11ax, 802.11be, 802.11bn). The one or more communication links 505 may support various data rates, frequency bands, and modulation schemes. The one or more communication links 505 may facilitate bidirectional transmission of data packets, management frames, and control signals. In various embodiments, each of the one or more communication links 505 may be dynamically adapted based on signal quality, network congestion, or device capabilities to optimize performance and maintain connectivity.

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

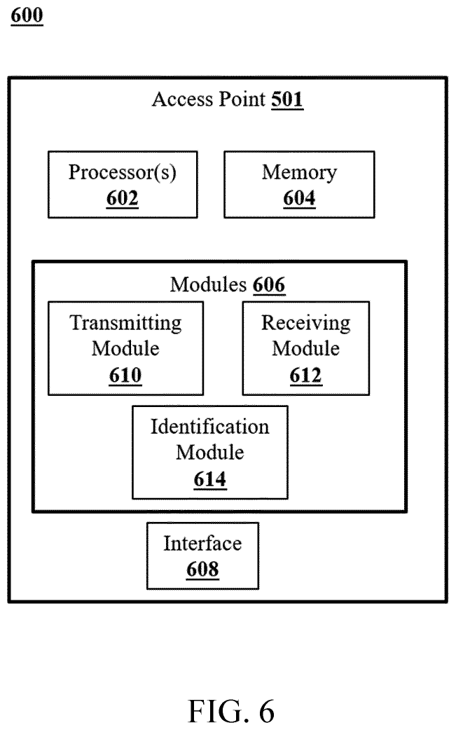

FIG. 6 is a block diagram illustrating an example configuration of a system for managing the beacon frame, according to various embodiments. In an embodiment, the system may correspond to the AP 501. FIG. 6 has been explained in conjunction with FIG. 5 for the sake of brevity of the disclosure.

The system may include one or more processors (e.g., including processing circuitry) 602 (hereinafter referred to as the processor 602), a memory 604, modules (e.g., including circuitry and/or executable program instructions) 606, and an interface (e.g., including circuitry) 608. In an example embodiment, the one or more processors 602 may be operatively coupled to the memory 604, the modules 606, and the interface 608.

In an embodiment, The processor 602 can include one or more processors or other processing devices that control the overall operation of the AP 501. The processor 602 can include processing circuitry, which can be implemented by a circuit, for example a system on chip (SoC) or an integrated circuit (IC). The processor 602 may include the combination of one or more processors such as a CPU, GPU, MPU, an application processor (AP), and a communication processor (CP). For example, the processor 602 could control the reception of forward channel signals and the transmission of reverse channel signals by the modules 606 in accordance with well-known principles. The processor 602 could support additional functions as well, such as more advanced wireless communication functions. For instance, the processor 602 could support beam forming or directional routing operations in which outgoing signals from multiple antennas are weighted differently to effectively steer the outgoing signals in a desired direction. The processor 602 could also support OFDMA operations in which outgoing signals are assigned to different subsets of subcarriers for different recipients (e.g., different user devices). Any of a wide variety of other functions could be supported in the AP 501 by the processor 602 including facilitating enhancing cross-link power save state and power management mode indication. In some examples, the processor 602 includes at least one microprocessor or microcontroller. The processor 602 is also capable of executing programs and other processes resident in the memory 604, such as an OS. The memory 604 stores instructions that, when executed by the at least one processor 602 individually or collectively, cause the AP 501 to perform the methods and/or the operations described herein. The processor 602 can move data into or out of the memory 230 as required by an executing process. The processor 602 may include at least one data processor for executing processes in a Virtual Storage Area Network. The processor 602 may include specialized processing units such as integrated system (bus) controllers, memory management control units, floating point units, graphics processing units, digital signal processing units, etc. In an embodiment, the processor 602 may include a Central Processing Unit (CPU), a Graphics Processing Unit (GPU), or both. The processor 602 may be one or more general processors, Digital Signal Processors (DSPs), application-specific integrated circuits, Field-Programmable Gate Arrays (FPGAs), servers, networks, digital circuits, analog circuits, combinations thereof, or other now-known or later developed devices for analyzing and processing data. The processor 602 may execute a software program, such as code generated manually (e.g., programmed) to perform the desired operation. The processor 602 may implement various techniques, such as, but not limited to, image processing, data extraction, Artificial Intelligence (AI), Machine Learning (ML), Deep Learning (DL), and so forth, to achieve the desired objective. Thus, the processor 602 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the processor 602 may be configured to perform the functions of the system or the AP 501.

The processor 602 may be disposed in communication with one or more Input/Output (I/O) devices, such as the user devices 503, via the interface 608. The interface 608 may include various circuitry and employ communication Code-Division Multiple Access (CDMA), High-Speed Packet Access (HSPA+), Global System For Mobile Communications (GSM), Long-Term Evolution (LTE), WiMax, Wi-Fi, or the like, etc.

In an embodiment, the processor 602 may be disposed in communication with a communication network via a network interface. In an embodiment, the network interface may be the interface 608. The network interface may connect to the communication network to enable connection of the system with the outside environment and/or device/system. The network interface may employ connection protocols, including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The AP 501 may include at least one processor including processing circuitry. The at least one processor may include the combination of one or more processors such as the processor 602, the processing circuitry in the modules 606, a CPU, GPU, MPU, an application processor (AP), and a communication processor (CP).

The memory 604 may be communicatively coupled to the processor 602. The memory 604 may be configured to store data and instructions executable by the processor 602. The memory 604 stores instructions that, when executed by the at least one processor 602 individually or collectively, cause the AP 501 to perform the methods and/or the operations described herein. In an embodiment, the memory 604 may communicate via a bus within the system. The memory 604 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 604 may include a cache or random-access memory for the processor 602. In alternative examples, the memory 604 is separate from the processor 602, such as a cache memory of a processor, the system memory, or other memory. The memory 604 may be an external storage device or database for storing data. The memory 604 may be operable to store instructions executable by the processor 602. The functions, acts, or tasks illustrated in the figures or described may be performed by the programmed processor 602 for executing the instructions stored in the memory 604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 604 may further include a database to store the data. Further, the memory 604 may include an operating system for performing one or more tasks of the system, as performed by a generic operating system in the communications domain.

For the sake of brevity, the architecture and standard operations of the processor 602 and the memory 604 are not discussed in detail. In an embodiment, the memory 604 may be configured to store the information as required by the processor 602 to perform the techniques described herein.

The modules 606, amongst other things, include routines, programs, objects, components, data structures, etc., which perform particular tasks or implement data types. The modules 606 may also be implemented as signal processor(s), state machine(s), logic circuits, and/or any other device or component that manipulates signals based on operational instructions. The modules 606 may be configured to one or more operations of the system and/or the processor 602.

Further, the modules 606 can be implemented in hardware, instructions executed by a processing unit, or by a combination thereof. The processing unit can comprise a computer, the processor 602, a state machine, a logic array, or any other suitable device capable of processing instructions. The processing unit can be a general-purpose processor that executes instructions to cause the general-purpose processor to perform the required tasks or the processing unit can be dedicated to performing the required functions. In an embodiment of the present disclosure, the modules 606 may be machine-readable instructions (software) that, when executed by a processor/processing unit, perform any of the described functionalities. Furthermore, the data serves, amongst other things, as a repository for storing data processed, received, and generated by one or more of the modules. The modules 606 may include a transmitting module 610, a receiving module 612, and an identification module 614.

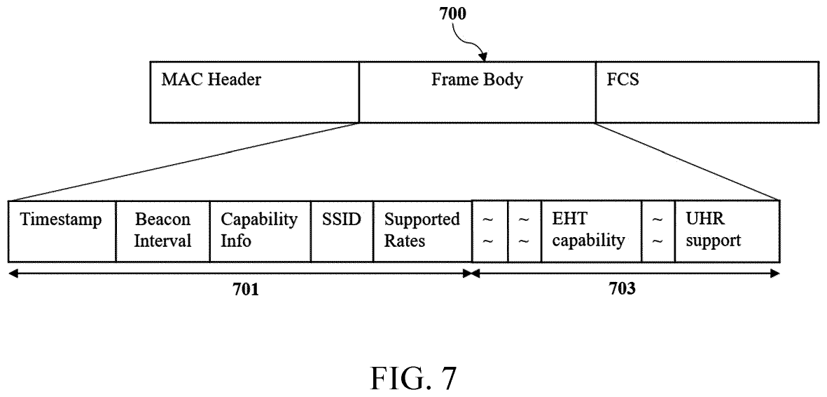

In an embodiment, transmit (TX) processing circuitry in the transmitting module 610 and/or processor 602 transmits analog or digital data (such as voice data, web data, e-mail, or interactive video game data) from the processor 602. The TX processing circuitry can include processing circuitry, which can be implemented by a circuit, for example a system on chip (SoC) or an integrated circuit (IC). The TX processing circuitry can be controlled by the controller/processor 602. The transmitting module 610 may be configured to transmit a beacon frame to one or more user devices, such as the user devices 503. The beacon frame may include, but is not limited to, a short indicator for indicating support of UHR capabilities, a short information of the UHR capabilities, and periodic transmission information of the UHR capabilities. For example, the transmitting module 610 may notify the user devices 503 that the access point (AP) 501 supports UHR capabilities. The beacon frame has been further explained in reference to FIGS. 7-15.

In response, the receiving module 612 may be configured to receive one or more first UHR capabilities associated with at least one UHR capable user device among the one or more user devices. The one or more first UHR capabilities may be used by the AP 501 to provide UHR capabilities associated with the AP 501 (referred to as one or more second UHR capabilities) to the at least one UHR capable user device, such as the smartphone 503A and the laptop 503E.

FIG. 7 is a diagram illustrating an example frame structure of the beacon frame 700 indicating the support for the UHR capabilities, according to various embodiments. In an embodiment, the short indicator for indicating the support for the UHR capabilities may be a one bit indicator set to 1 for indicating support for the UHR. The bit indicates that it is a UHR AP. As shown in FIG. 7, the beacon frame 700 includes mandatory fields 701 and optional fields 703. The optional fields 703 may include an additional field, e.g., UHR support. It can be noted that the rest of the beacon frame 700 may be similar to a legacy beacon frame. Accordingly, in an embodiment, the short indicator may be included in the legacy beacon frame. In an example embodiment, the UHR support may be defined as in Table 1.

TABLE 1

| Order | Information | Notes |
|---|---|---|
| Last-n | UHR Support | UHR support is set to 1 when |
| | | dot11UHROptionImplemented |
| | | is TRUE; otherwise, the bit is |
| | | set to 0. |

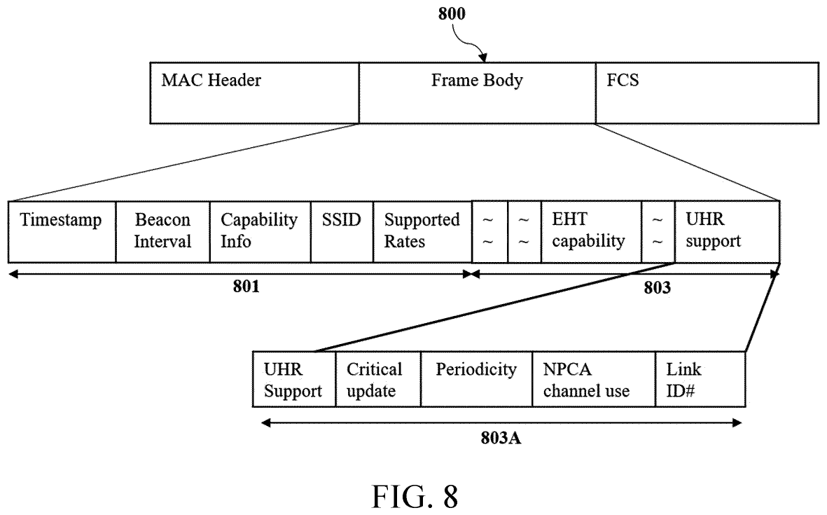

In an embodiment, the beacon frame may indicate the short information of the UHR capabilities, as shown in FIG. 8.

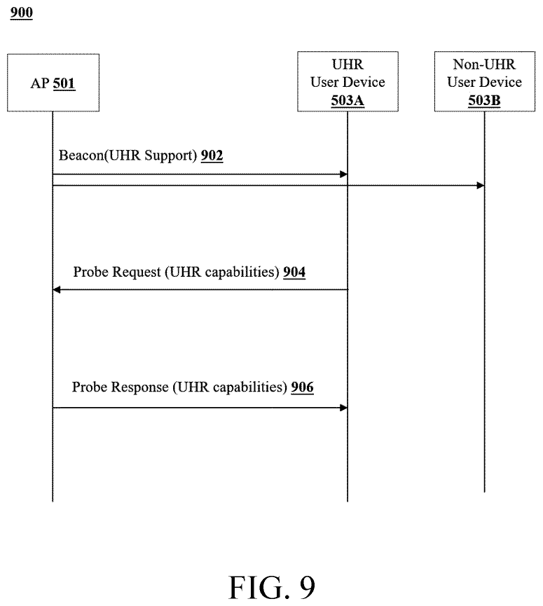

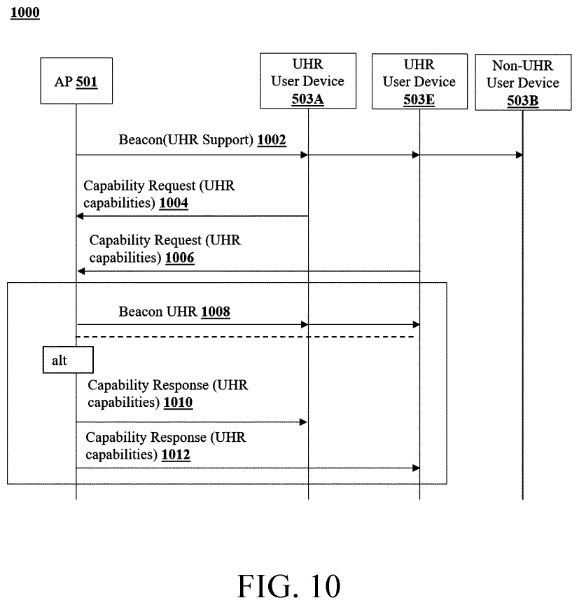

FIG. 8 is a diagram illustrating an example frame structure of the beacon frame 800 including the short information of UHR capabilities, according to various embodiments. As shown in FIG. 8, the beacon frame 800 includes mandatory fields 801 and optional fields 803. The optional fields 803 may include an additional field, e.g., UHR support field 803A. The UHR support field 803A may include the short information of the UHR capabilities. As shown, the short information may include a UHR support bit indicating whether the AP 501 supports the UHR. If the AP 501 supports the UHR, the UHR support bit may be set to 1. Otherwise, the UHR support bit may be set to 0. The UHR support field 803A may include a link information, a Non-Preferred Channels (NPCA) use information, and a periodicity information. The link information may indicate a link identification (Link ID) identifying a predefined communication link for transmitting the one or more second UHR capabilities. The predefined communication link may be different than a communication link used for transmitting the beacon frame. The link information can be used to indicate which link has updates with UHR information. The NPCA use information may indicate the NPCA channel information, using which the AP 501 may transmit the one or more second UHR capabilities. The periodicity information may indicate a periodicity with which the AP 501 may transmit the one or more second UHR capabilities. The one or more second UHR capabilities may be transmitted in accordance with techniques explained in reference to FIGS. 9 and 10 in the following paragraphs. The short information may also include a version information of the one or more second UHR capabilities. The version information e.g. critical update field may be used to identify the critical updates of the one or more second UHR capabilities or configurations and operating parameters of UHR. It can also follow baseline rules to indicate the BSS parameter change count and can be incremented to indicate new versions of UHR configurations and operating parameters to be received by the user device. Further, the version information may be a one-bit information that may indicate if there is an update to the one or more second UHR capabilities. Accordingly, the short information may be of a predefined length, such as 1 octet. It can be noted that the rest of the beacon frame 800 is similar to a legacy beacon frame. Accordingly, in an embodiment, the short information may be included in the legacy beacon frame. In an example embodiment, the UHR support including the short information may be defined as in Table 2.

TABLE 2

| | Infor- | |
|---|---|---|
| Order | mation | Notes |
| Last- | UHR | Bit 0: UHR capability indication - set to 1 if |
| n | Support | dot11UHROptionImplemented is TRUE, otherwise |
| | | the bit is set to 0 |
| | | Bit 1: Set to 1 if UHR update is required, else set to 0 |
| | | The remaining bits can include periodicity information, |
| | | NPCA channel use information, and link information |
| Last- | Critical | This is an indicator of the version information or |
| n + 1 | Update | critical update field that can be used to indicate that |
| | | the UHR configuration or operating parameters have a |
| | | critical update. Alternatively, it can also follow |
| | | baseline procedures like BSS parameter change count |
| | | value. |
| Last- | Periodicity | It is an optional field that can indicate the periodicity |
| n + 2 | | of the UHR specific Beacon frame which is a new |
| | | broadcast message in response to multiple probe |
| | | requests from UHR Stations. |
| Last- | NPCA | This is an optional field that can indicate whether the |
| n + 3 | channel | Beacons for UHR are being transmitted on the non- |
| | use | primary channel. |
| Last- | Link ID | This field can indicate the Link ID on which Beacons |
| n + 4 | | for UHR are transmitted. It can also indicate the Link |
| | | ID on which UHR critical updates are expected. |

Accordingly, the transmitting module 610 may include the link information in the beacon frame using the predefined communication link. The transmitting module 610 may also include the version information of the one or more second UHR capabilities in the beacon frame to identify the critical updates of the one or more second UHR capabilities.

In an embodiment, when the beacon frame comprises the short indicator of the UHR capabilities, the AP 501 may transmit the one or more UHR capabilities using a Request/Response mechanism, as shown in FIG. 9.

FIG. 9 is a signal flow diagram 900 illustrating example operations for transmitting the one or more second UHR capabilities, according to various embodiments. As shown, the AP 501 is connected to a UHR capable user device 503A (referred to as device 503A) and a Non-UHR capable user device 503B (referred to as device 503B). Accordingly, at operation 902, the AP 501 may periodically transmit the beacon frame to the device 503A and the device 503B. The beacon frame may comprise the short indicator indicating the UHR support, e.g., the “UHR support” bit is set to 1. Accordingly, both devices 503A and 503B may receive the beacon frame. However, as the device 503B is a Non-UHR capable device, the device 503B may ignore the short indicator. On the other hand, the device 503A is capable of reading the beacon frame with the short indicator. Accordingly, at operation 904, the AP 501 may receive a request frame from the device 503A. The request frame may comprise a request for receiving the one or more second UHR capabilities. In an embodiment, the AP 501 may receive the request in a capability request frame. In an embodiment, the AP 501 may receive the request in a probe request. In response, at operation 906, the AP 501 may transmit the one or more second UHR capabilities to the device 503A via a Response frame. Accordingly, the AP 501 does not need to send the complete set of UHR capabilities in the beacon frame, resulting in a reduction in resources and airtime. It should be noted that although FIG. 9 illustrates only one UHR capable user device and one Non-UHR capable user device, the AP 501 may be connected to multiple UHR capable and multiple Non-UHR capable user devices. Accordingly, the method described in FIG. 9 may be performed between the AP 501 and one or more UHR capable user devices, as well as one or more Non-UHR capable user devices.

In an embodiment, when the beacon frame comprises the short indicator of the UHR capabilities, the AP 501 may transmit the one or more UHR capabilities using a beacon UHR frame, as shown in FIG. 10.

FIG. 10 is a signal flow diagram 1000 illustrating example operations for transmitting the one or more second UHR capabilities, according to various embodiments. As shown, the AP 501 is connected to a first UHR capable user device 503A (referred to as device 503A), a second UHR capable user device 503E (referred to as device 503E), and the Non-UHR capable user device 503B (referred to as device 503B). Accordingly, at operation 1002, the AP 501 may periodically transmit the beacon frame to the device 503A, the device 503E, and the device 503B. The beacon frame may comprise the short indicator indicating the UHR support, e.g., the “UHR support” bit is set to 1. Accordingly, all the devices 503A, 503E, and 503B may receive the beacon frame. However, as the device 503B is a Non-UHR capable device, the device 503B may ignore the short indicator. On the other hand, the devices 503A and 503E are capable of reading the beacon frame with the short indicator. Accordingly, at operation 1004, the AP 501 may receive a request frame from the device 503A. The request frame may comprise a request for receiving the one or more second UHR capabilities. In an embodiment, the AP 501 may receive the request in a capability request frame. In a further embodiment, the AP 501 may receive the request in a probe request. In an embodiment, the AP 501 may receive the request in a predefined message defined exclusively to only include the one or more second UHR capabilities. At operation 1006, the AP 501 may receive the request frame from the device 503E. In response, at operation 1008, the AP 501 may transmit the one or more second UHR capabilities to the devices 503A and 503E via a beacon UHR frame. At operations 1010 and 1012, the AP 501 may transmit the one or more second UHR capabilities to the devices 503A and 503E in accordance with techniques as described in reference to FIG. 9. In an embodiment, AP 501 may decide to perform either operation 1008 alone or operation 1008 followed by operations 1010 and 1012. For example, based on its implementation logic and the number of nearby UHR capable user devices, the UHR AP 501 may decide to begin broadcasting one or more secondary UHR capabilities in the response frame or the beacon UHR frame during the next beacon interval. Accordingly, the AP 501 does not need to send the complete set of UHR capabilities in the beacon frame, resulting in a reduction in resources and airtime. It should be noted that although FIG. 10 illustrates only one UHR capable user device and one Non-UHR capable user device, the AP 501 may be connected to multiple UHR capable and multiple Non-UHR capable user devices. Accordingly, the method as explained in FIG. 10 may be performed between the AP 501 and one or more UHR capable user devices, as well as one or more Non-UHR capable user devices.

In an embodiment, the beacon UHR frame shall be a broadcast frame and may include, but is not limited to, a time stamp, an information associated with the beacon UHR frame (e.g., beacon UHR information), periodicity of the beacon UHR frame, and one or more features associated with the AP 501. The timestamp may be used for additional synchronization. The beacon UHR information may indicate the associated Basic Service Set (BSS) ID(s), link information, and channel on which the Beacon UHR is transmitted. The beacon UHR information may also indicate version information of the one or more second UHR capabilities. The periodicity may indicate the periodicity in Time units after which the beacon UHR frames are to be transmitted. The one or more features associated with the AP 501 may include, but are not limited to, a list of element IDs and associated features, such as power save feature, Multi-Link Access Point (M-AP), NPCA, etc. In an example embodiment, the information in the beacon UHR frame has been illustrated as in Table 3.

TABLE 3

| | Infor- | |
|---|---|---|
| Order | mation | Notes |
| X_1 | Timestamp | This can be used for additional synchronization |
| X_2 | Beacon | This field can optionally represent the associated |
| | UHR Info | Basic Service Set (BSS) ID(s), Link information, |
| | | and channel on which the Beacon UHR frame is |
| | | transmitted. |
| X_3 | Beacon | This represents the periodicity in Time units after |
| | Periodicity | which the beacon UHR frames are to be |
| | | transmitted. |
| X_4 to | Features | A list of element IDs and associated features such |
| X_n | | as power save feature, M-AP, NPCA, etc. |

It should be noted that Table 3 illustrates only an example of the beacon UHR frame format. The order numbers X_1 to X_n are shown for illustrative purposes only.

In an embodiment, when the beacon frame includes the short indicator, the transmitting module 610 may be configured to transmit the one or more second UHR capabilities on an NPCA, such as a secondary channel. The NPCA may refer to a channel not preferred by the AP 501 for primary data transmission but is available for use.

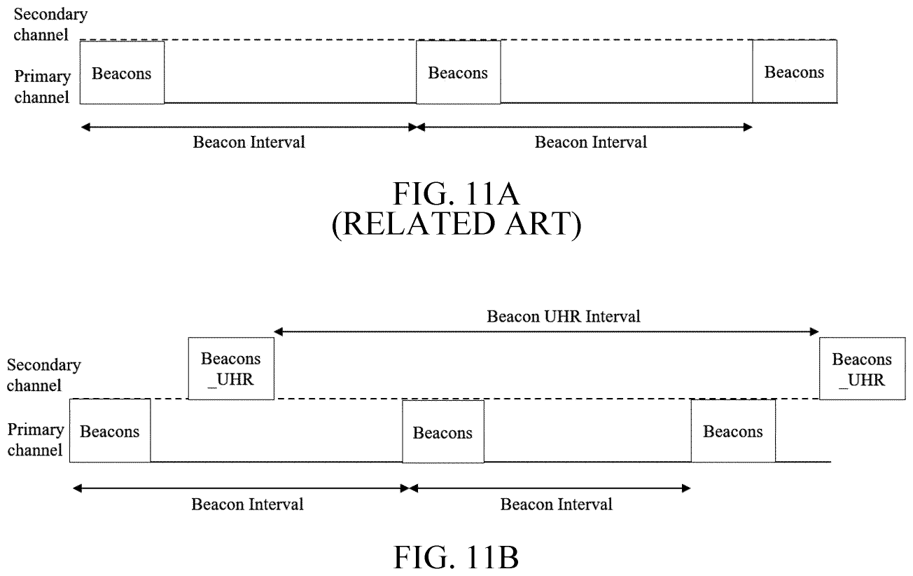

FIG. 11A is a diagram illustrating an example scenario of non-utilization of a non-primary channel, in accordance with related art. FIG. 11B is a diagram illustrating an example scenario of the utilization of a non-primary channel, according to various embodiments. As shown in FIG. 11A, even though the secondary channel is available, the AP is not utilizing the same. On the other hand, as shown in FIG. 11B, the Beacon UHR frame may be transmitted on the secondary channel. Accordingly, the AP 501 may transmit the one or more second UHR capabilities on the NPCA. Hence, when the one or more second UHR capabilities are modularized into a separate management frame, e.g., the beacon UHR frame, there is flexibility to send the beacon UHR frame on the secondary channel as well. In such a scenario, the beacon frame may include a non-primary channel information. Accordingly, the secondary channel can be used to send the beacon UHR frame when there is an update or when few UHR user devices are present in the BSS.

In an embodiment, when the beacon frame includes the short indicator, the transmitting module 610 may be configured to transmit the one or more second UHR capabilities on the predefined communication link. The predefined communication link may be different than the communication link used to transmit the beacon frame.

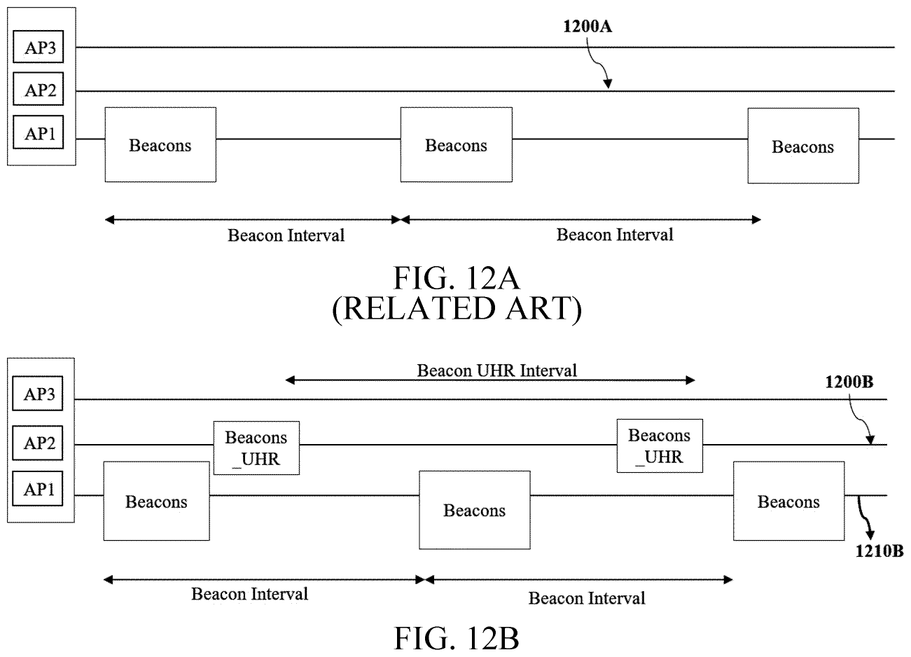

FIG. 12A is a diagram illustrating an example scenario of beacon transmissions, in accordance with related art. FIG. 12B is a diagram illustrating an example scenario of Beacons and Beacons for UHR, according to various embodiments. As shown in FIG. 12A, even though the predefined communication link 1200A is available, the AP is not utilizing the same. On the other hand, as shown in FIG. 12B, the Beacon UHR frame may be transmitted on the predefined (e.g., specified) communication link 1200B. As can be seen, the predefined communication link 1200B is different than the communication link used for transmitting the beacon frame, such as the communication link 1210B. Accordingly, the AP 501 may transmit the one or more second UHR capabilities on the predefined communication link 1200B. Hence, when the one or more second UHR capabilities are modularized into a separate management frame, e.g., the beacon UHR frame, there is flexibility to send the beacon UHR frame on the predefined communication link 1200B as well. Accordingly, the predefined communication link 1200B can be effectively utilized to send the beacon UHR frame. The UHR capable user devices can directly monitor the other links for the beacon UHR frame. In an embodiment, when there is a critical update on any particular link, the Beacon can indicate the Link ID and the corresponding Link can periodically broadcast the Beacon UHR with the updated parameters.

In an embodiment, when the beacon frame includes the periodic transmission information of the UHR capabilities, the transmitting module 610 may be configured to transmit information associated with dynamic periodic time interval for transmitting the one or more second UHR capabilities in the Beacon UHR frame.

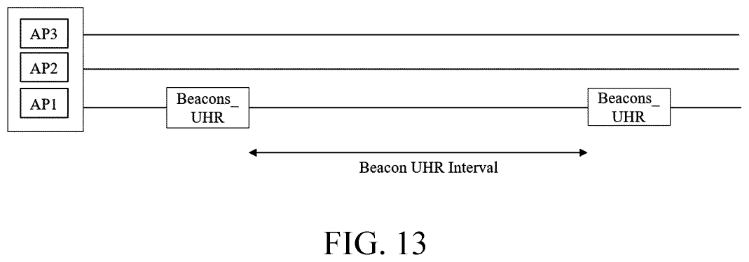

FIG. 13 is a diagram illustrating an example scenario of transmitting the beacon UHR frame in dynamic intervals, according to various embodiments. As shown, the beacon UHR frame can be broadcast with dynamic periodic time intervals to legacy Beacons. Accordingly, the AP 501 has the flexibility to send the beacon UHR frames at a larger interval than current legacy beacon frames. Such an implementation may reduce airtime occupation of the beacons and enable a more optimized utilization of resources.

In an embodiment, the one or more second UHR capabilities may be transmitted in a scenario of roaming.

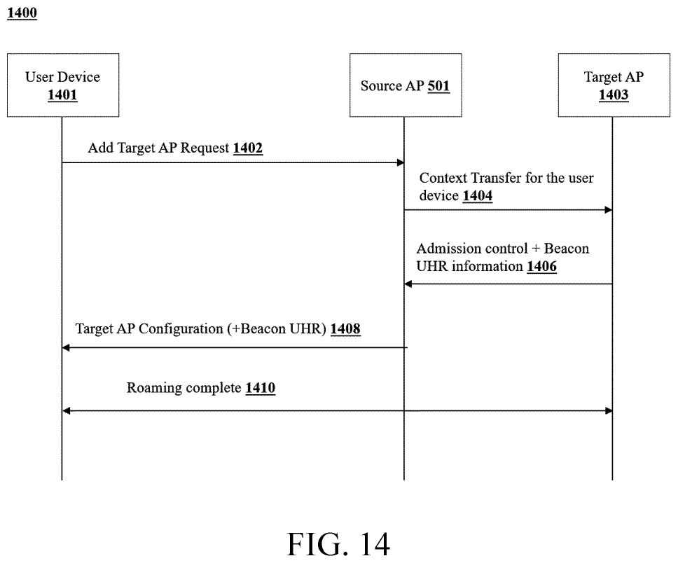

FIG. 14 is a signal flow diagram 1400 illustrating example operations for the transmission of the one or more second UHR capabilities in the roaming scenario, according to various embodiments. In an embodiment, the source AP may correspond to the AP 501, and the user device 1401 may correspond to the user device 503A. As shown, at operation 1402, the source AP 501 may receive an addition request indicating an identification information of a target AP 1403 from the user device 1401. At operation 1404, the source AP 501 may transfer the context associated with the user device 1401 to the target AP 1403. At operation 1406, the source AP 501 may receive one or more third UHR capabilities associated with the target AP 1403 from the target AP 1403. In response, at operation 1408, the source AP 501 may transmit the configuration of the target AP 1403 along with the one or more third UHR capabilities to the user device 1401. In an embodiment, the source AP 501 may transmit the one or more third UHR capabilities in a beacon UHR frame. Accordingly, at operation 1410, the roaming procedure is completed and the user device 1401 is associated with the target AP 501. It should be noted that although FIG. 14 illustrates only one UHR capable user device, the AP 501 may be connected to multiple UHR capable user devices. Accordingly, the method as explained in FIG. 14 may be performed between the AP 501 and one or more UHR capable user devices. Further, the method described in reference to FIG. 14 offers a high-level overview of Beacon UHR information flow and is not intended to represent the specific sequence of roaming steps. Regardless of the sequence adopted by the standards, the disclosed techniques provide a framework for including the Beacon UHR frame to facilitate information transfer from the target AP 1403 to the user device 1401. Hence, with the availability of a separate beacon UHR frame, beacon configuration information may be transmitted in a signaling message from the target AP 1403 to the source AP 501 and subsequently to the user device 1401. As a result, the user device 1401 is not required to acquire and decode the beacon frame from the target AP 1403 upon arrival to obtain capability and configuration details. The introduction of the Beacon UHR Information Element (IE) enables the direct transfer of beacon-related information from the target AP 1403 to the user device 1401, thereby reducing overhead and improving efficiency in roaming procedures.

In an embodiment, the transmitting module 610 may be configured to transmit the one or more second UHR capabilities in the beacon frame upon receiving a request from a number of predefined UHR capable user devices. For example, if the receiving module 612 receives the request for the one or more second UHR capabilities from 5 UHR capable user devices, then the transmitting module 610 may transmit the one or more second UHR capabilities in the beacon frame. It should be noted that the number of predefined UHR capable user devices may be configurable.

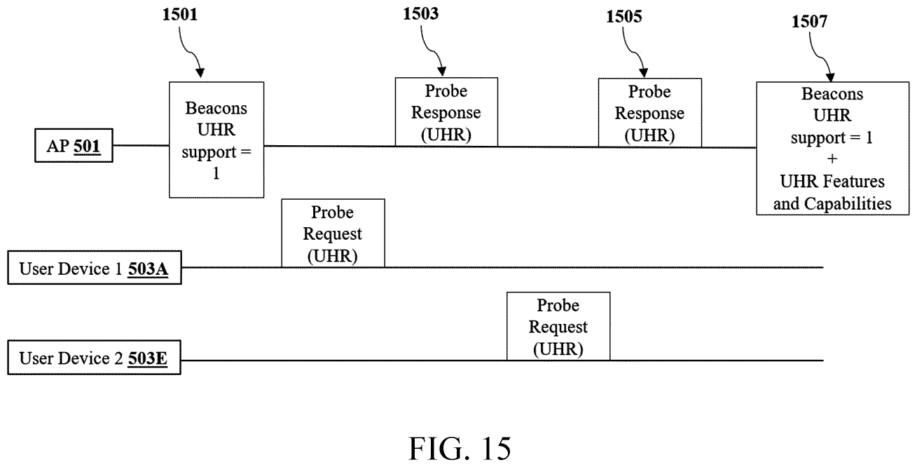

In an embodiment, the AP 501 may transmit the one or more second UHR capabilities in a legacy beacon frame, as shown in FIG. 15.

FIG. 15 is a diagram illustrating an example scenario for transmitting the one or more second UHR capabilities in a legacy beacon frame, according to various embodiments. For example, the identification module 614 may identify a pre-determined (e.g., specified) set of UHR capable user devices among the one or more user devices in the BSS associated with the AP 501. The transmitting module 610 may include the one or more second UHR capabilities in a predefined beacon frame, such as the legacy beacon frame as per current specification definitions. As shown in FIG. 15, the AP 501 can initially include only the short indicator in the beacon frame, e.g., frame 1501. Once the AP 501 identifies the pre-determined set of UHR capable user devices, the AP 501 may transmit the one or more second UHR capabilities in the response frame, e.g., frames 1503 and 1505. The AP 501 may also transmit the one or more second UHR capabilities in the beacon UHR frame, e.g., frame 1507. For example, the AP 501 may update the beacon frame including the updated UHR configurations, parameters, and capabilities upon identification of the presence of UHR capable user devices.

Further, in an embodiment, the Non-UHR capable user devices may ignore the short indicator, the short information, and the periodic transmission information in the beacon frame, such as in FIGS. 9 and 10.

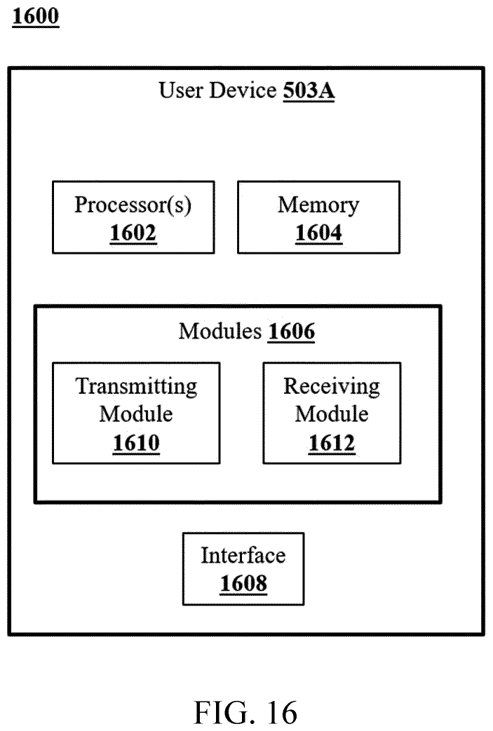

FIG. 16 is a block diagram illustrating an example configuration of a system for managing the beacon frame, according to various embodiments. In an embodiment, the system may correspond to any of the UHR capable user devices among the user devices 503, such as the user device 503A. The user device 503A may include at least one processor including processing circuitry. The at least one processor may include the combination of one or more processors such as the processor 1602, the processing circuitry in the modules 1606, a CPU, GPU, MPU, an application processor (AP), and a communication processor (CP).

The system may include one or more processors (e.g., including processing circuitry) 1602 (hereinafter referred to as the processor 1602), a memory 1604, modules (e.g., including various circuitry and/or executable program instructions) 1606, and an interface (e.g., including circuitry) 1608. In an example embodiment, the one or more processors 1602 may be operatively coupled to the memory 1604, the modules 1606, and the interface 1608.

In an embodiment, the processor 1602 may include at least one data processor for executing processes in a Virtual Storage Area Network. The processor 1602 may include specialized processing units such as integrated system (bus) controllers, memory management control units, floating point units, graphics processing units, digital signal processing units, etc. In an embodiment, the processor 1602 may include a Central Processing Unit (CPU), a Graphics Processing Unit (GPU), or both. The processor 1602 may be one or more general processors, Digital Signal Processors (DSPs), application-specific integrated circuits, Field-Programmable Gate Arrays (FPGAs), servers, networks, digital circuits, analog circuits, combinations thereof, or other now-known or later developed devices for analyzing and processing data. The processor 1602 may execute a software program, such as code generated manually (e.g., programmed) to perform the desired operation. The processor 1602 may implement various techniques, such as, but not limited to, image processing, data extraction, Artificial Intelligence (AI), Machine Learning (ML), Deep Learning (DL), and so forth, to achieve the desired objective. Thus, the processor 1602 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the processor 1602 may be configured to perform the functions of the system or the user device 503A.

The processor 1602 may be disposed in communication with one or more Input/Output (I/O) devices, such as the user devices 503, via the interface 1608. The interface 1608 may employ communication Code-Division Multiple Access (CDMA), High-Speed Packet Access (HSPA+), Global System For Mobile Communications (GSM), Long-Term Evolution (LTE), WiMax, Wi-Fi or the like, etc. The processor 1602 can include processing circuitry, which can be implemented by a circuit, for example a system on chip (SoC) or an integrated circuit (IC). The processor 1602 may include the combination of one or more processors such as a CPU, GPU, MPU, an application processor (AP), and a communication processor (CP).

In an embodiment, the processor 1602 may be disposed in communication with a communication network via a network interface. In an embodiment, the network interface may be the interface 1608. The network interface may connect to the communication network to enable connection of the system with the outside environment and/or device/system. The network interface may employ connection protocols, including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 1604 may be communicatively coupled to the processor 1602. The memory 1604 may be configured to store data and instructions executable by the processor 1602. The memory 1604 stores instructions that, when executed by the at least one controller/processor 1604 individually or collectively, cause the user device 503A to perform the methods and/or the operations described herein. In an embodiment, the memory 1604 may communicate via a bus within the system. The memory 1604 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 1604 may include a cache or random-access memory for the processor 1602. In various examples, the memory 1604 may be separate from the processor 1602, such as a cache memory of a processor, the system memory, or other memory. The memory 1604 may be an external storage device or database for storing data. The memory 1604 may be operable to store instructions executable by the processor 1602. The functions, acts, or tasks illustrated in the figures or described may be performed by the programmed processor 1602 for executing the instructions stored in the memory 1604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 1604 may further include a database to store the data. Further, the memory 1604 may include an operating system for performing one or more tasks of the system, as performed by a generic operating system in the communications domain.

For the sake of brevity, the architecture and standard operations of the processor 1602 and the memory 1604 are not discussed in detail. In an embodiment, the memory 1604 may be configured to store the information as required by the processor 1602 to perform the techniques described herein.

The modules 1606, amongst other things, include routines, programs, objects, components, data structures, etc., which perform particular tasks or implement data types. The modules 1606 may also be implemented as signal processor(s), state machine(s), logic circuits, and/or any other device or component that manipulates signals based on operational instructions. The modules 1606 may be configured to one or more operations of the system and/or the processor 1602. The modules 1606 (for example, transmitting module 1610 and/or receiving module 1612) can include processing circuitry, which can be implemented by a circuit, for example a system on chip (SoC) or an integrated circuit (IC). The modules 1606 can be controlled by the processor 1602.

Further, the modules 1606 can be implemented in hardware, instructions executed by a processing unit, or by a combination thereof. The processing unit can comprise a computer, the processor 1602, a state machine, a logic array, or any other suitable device capable of processing instructions. The processing unit can be a general-purpose processor that executes instructions to cause the general-purpose processor to perform the required tasks, or the processing unit can be dedicated to performing the required functions. In an embodiment of the present disclosure, the modules 1606 may be machine-readable instructions (software) that, when executed by a processor/processing unit, perform any of the functionalities described. Furthermore, the data serves, amongst other things, as a repository for storing data processed, received, and generated by one or more of the modules. The modules 1606 may include a transmitting module 1610, and a receiving module 1612.

In an embodiment, the receiving module 1612 may be configured to receive the beacon frame from the AP 501. The beacon frame may include, but is not limited to, the short indicator for indicating support of the UHR capabilities, the short information of the UHR capabilities, and periodic transmission information of the UHR capabilities. It should be noted that the beacon frame may correspond to the beacon frame as explained in reference to FIGS. 6-15. Hence, the details of the beacon frame are not repeated here for the sake of brevity of the disclosure. In response, the transmitting module 1610 may be configured to transmit the one or more first UHR capabilities associated with the user device.

In an embodiment, when the beacon frame comprises the short indicator of the UHR capabilities, the transmitting module 1610 may be configured to transmit the request frame comprising the request for receiving the one or more second UHR capabilities. In an embodiment, the transmitting module 1610 may be configured to transmit the request in the Request frame. In response, the receiving module 1612 may be configured to receive the one or more second UHR capabilities via a Response frame. It should be noted that the user device 503 may transmit the request and receive the one or more second UHR capabilities in accordance with techniques as explained in reference to FIG. 9. Hence, the details of the same are not repeated here for the sake of brevity of the disclosure.

In an embodiment, when the beacon frame comprises the short indicator of the UHR capabilities, the receiving module 1612 may be configured to receive the one or more second UHR capabilities in the beacon UHR frame. It should be noted that the user device 503 may receive the beacon UHR frame in accordance with techniques as explained in reference to FIG. 10. Hence, the details of the same are not repeated here for the sake of brevity of the disclosure.

In an embodiment, when the beacon frame includes the periodic transmission information of the UHR capabilities, the receiving module 1612 may be configured to receive information associated with dynamic periodic time interval for transmitting the one or more second UHR capabilities in the Beacon UHR frame. It should be noted that the user device 503 may receive the information associated with dynamic periodic time interval in accordance with techniques as explained in reference to FIG. 13. Hence, the details of the same are not repeated here for the sake of brevity of the disclosure.

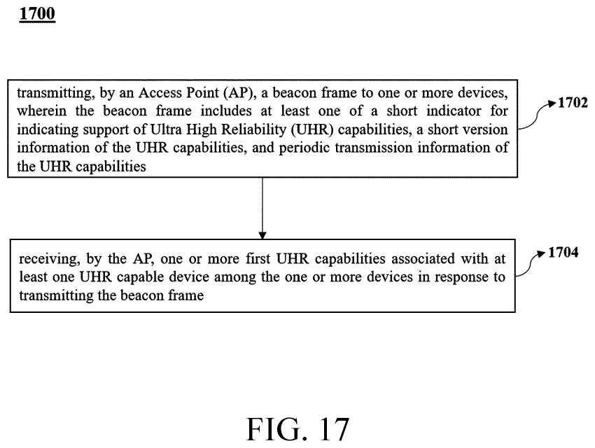

FIG. 17 is a flowchart illustrating an example method 1700 for managing the beacon frame, according to various embodiments. As shown, at operation 1702, the method 1700 may include transmitting, by the AP 501, the beacon frame to one or more user devices 503. The beacon frame may include, but is not limited to, the short indicator for indicating support of UHR, the short information of the UHR capabilities, and periodic transmission information of the UHR capabilities. At operation 1704, the method 1700 may include receiving, by the AP 501, the one or more first UHR capabilities associated with at least one UHR capable user device among the one or more user devices in response to transmitting the beacon frame.

While the above-discussed operations in FIG. 17 are shown and described in a particular sequence, the operations may occur in variations to the sequence in accordance with various embodiments. Further, a detailed description related to the various steps of FIG. 17 is already covered in the description related to FIGS. 6-15 and is not repeated here for the sake of brevity.

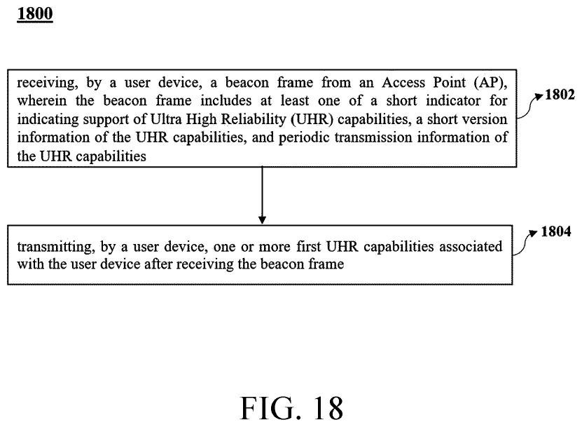

FIG. 18 is a flowchart illustrating an example method 1800 for managing the beacon frame, according to various embodiments. As shown, at operation 1802, the method 1800 may include receiving, by the user device 503A, the beacon frame from the AP 501. The beacon frame may include, but is not limited to, the short indicator for indicating support of UHR capabilities, the short information of the UHR capabilities, and periodic transmission information of the UHR capabilities. At operation 1804, the method 1800 may include transmitting, by the user device 503A, the one or more first UHR capabilities associated with the user device after receiving the beacon frame.

While the above-discussed operations in FIG. 18 are shown and described in a particular sequence, the operations may occur in variations to the sequence in accordance with various embodiments. Further, a detailed description related to the various steps of FIG. 18 is already covered in the description related to FIGS. 6-16 and is not repeated here for the sake of brevity.

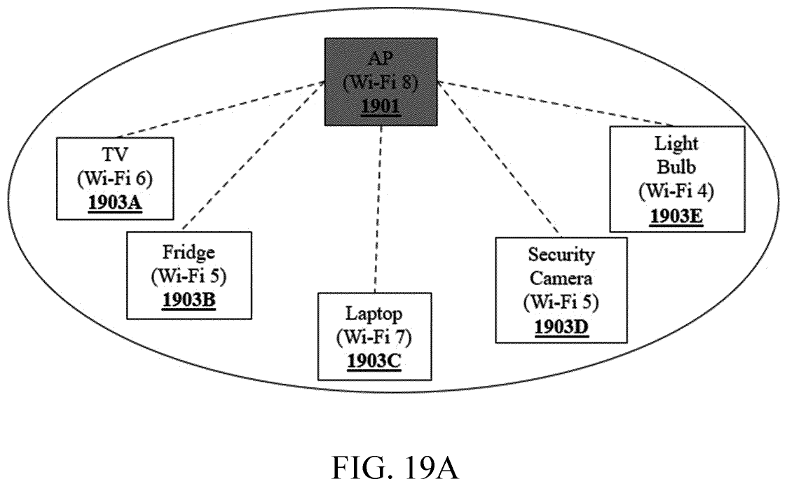

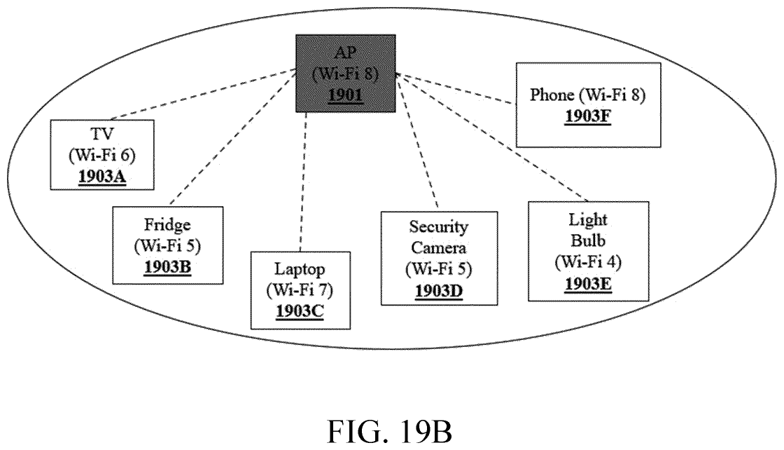

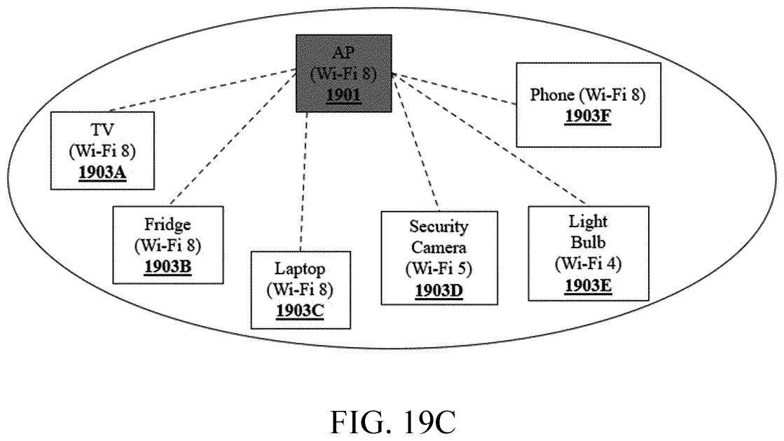

FIGS. 19A, 19B and 19C are diagrams illustrating example use cases of implementing the beacon frame, according to various embodiments. As shown in FIG. 19A, the AP 1901 is a UHR capable AP. However, all of the user devices 1903A-1903E are Non-UHR capable user devices. Hence, the AP 1901 may only include the short indicator in the beacon frame. Accordingly, if any UHR capable user device is connected to the AP 1901 in the future, the UHR capable user device will be aware that the AP 1901 supports UHR. As shown in FIG. 19B, as only one of the user devices 1903A-1903F, e.g., the user device 1903F is a UHR capable user device, the AP 1901 may transmit the beacon UHR at low periodicity or on the non-primary channel or the predefined communication link. However, if the number of UHR capable user devices is increased, then the AP 1901 may not transmit the beacon UHR at low periodicity or on the non-primary channel or the predefined communication link. For example, as shown in FIG. 19C, the number of UHR capable user devices is increased, e.g., user devices 1903A-1903C and 1903F. Hence, the AP 1901 may include the one or more second UHR capabilities in the beacon frame.

Further, the number of UHR capable user devices may vary depending on the time of the day. For example, as shown in FIG. 19A, from 9 AM to 6 PM, the AP 1901 may not be connected to any UHR capable user device. However, as shown in FIG. 19C, between 6 PM-9 AM, the AP 1901 may be connected to a number of UHR capable user devices. Accordingly, the AP 1901 may decide the mechanism to transmit the beacon frame. For example, if the AP 1901 is a part of a smart home, from 9 AM to 6 PM, occupants of the smart home may be out and about for work/school, etc. Accordingly, the AP 1901 may transmit the beacon frame in accordance with FIG. 19A. However, in the evening, the occupants of the smart home may return and each of the occupants may carry UHR capable user devices, such as smartphones. Hence, the AP 1901 may need to broadcast and support UHR features at this time only. Accordingly, the AP the AP 1901 may transmit the beacon frame in accordance with FIG. 19C.

Accordingly, the present disclosure provides various advantages. For example, the present disclosure reduces unnecessary airtime usage, improves efficiency, and minimizes/reduces power consumption through the implementation of the disclosed beacon frame.

In this disclosure, unless specifically stated otherwise, the use of the singular includes the plural, and the use of “or” may include “and/or.” Furthermore, the use of the terms “including” or “having” is not limiting. Any range described herein will be understood to include the endpoints and all values between the endpoints. Features of the disclosed example embodiments may be combined, rearranged, omitted, etc., within the scope of the disclosure to produce additional embodiments. Furthermore, certain features may sometimes be used to advantage without a corresponding use of other features.

While at least various example embodiments have been presented in the foregoing detailed description, it should be appreciated that a vast number of variations exist.

What is claimed is:

1. A user device associated with an access point (AP), the user device comprising:
at least one processor including processing circuitry; and
memory storing instructions that, when executed by the at least one processor individually or collectively, cause the user device to:
receive a beacon frame from the AP, wherein the beacon frame includes one or more of a short indicator for indicating support of Ultra High Reliability (UHR) capabilities, a short information of the UHR capabilities, and periodic transmission information of the UHR capabilities; and
transmit one or more first UHR capabilities associated with the user device in response to receiving the beacon frame.

2. The user device of claim 1, wherein based on the beacon frame including the short indicator of the UHR capabilities, the instructions, when executed by the at least one processor individually or collectively, cause the user device to:
transmit a request frame to the AP, the request frame comprising a request for receiving one or more second UHR capabilities associated with the AP; and
receive, from the AP, the one or more second UHR capabilities.

3. The user device of claim 2, wherein the transmitting of the request comprises:
transmitting the request in a capability request frame.

4. The user device of claim 2, the instructions, when executed by the at least one processor individually or collectively, cause the user device to:
receive, from the AP, the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

5. The user device of claim 1, wherein the short indicator includes a one bit indicator set to 1 indicating support for the UHR capabilities.

6. The user device of claim 1, wherein based on the beacon frame including the periodic transmission information of the UHR capabilities, the instructions, when executed by the at least one processor individually or collectively, cause the user device to:
receive, from the AP, information associated with dynamic periodic time interval for transmitting the one or more second UHR capabilities in a Beacon UHR frame.

7. The user device of claim 1, the instructions, when executed by the at least one processor individually or collectively, cause the user device to:
transmit, to the AP, an addition request indicating an identification information of a target AP;
transmit, to the AP, one or more third UHR capabilities associated with the target AP; and
receive, from the AP, the one or more third UHR capabilities associated with the target AP.

8. The user device of claim 1, wherein the user device includes a Non-UHR capable user device, wherein the Non-UHR capable user device is configured to ignore at least one of the short indicator, the short information, and the periodic transmission information in the beacon frame.

9. An access point (AP), comprising:
at least one processor including processing circuitry; and
memory storing instructions that, when executed by the at least one processor individually or collectively, cause the AP to:
transmit the beacon frame to one or more user devices connected with the AP, wherein the beacon frame includes at least one of a short indicator indicating support of Ultra High Reliability (UHR) capabilities, a short information of the UHR capabilities, and periodic transmission information of the UHR capabilities;
receive one or more first UHR capabilities associated with at least one UHR capable user device among the one or more user devices in response to transmission of the beacon frame.

10. The AP of claim 9, wherein based on the beacon frame including the short indicator of the UHR capabilities, the instructions that, when executed by the at least one processor individually or collectively, cause the AP to:
receive a request frame comprising a request for receiving one or more second UHR capabilities associated with the AP; and
transmit the one or more second UHR capabilities to the at least one UHR capable user device via a Response frame.

11. The AP of claim 10, wherein the instructions that, when executed by the at least one processor individually or collectively, cause the AP to receive the request in a capability request frame.

12. The AP of claim 10, wherein upon reception of the request, the instructions that, when executed by the at least one processor individually or collectively, cause the AP to: transmit the one or more second UHR capabilities in a beacon UHR frame, wherein the beacon UHR frame includes at least one of a time stamp, information associated with the beacon UHR frame indicating version information, periodicity of the beacon UHR frame, and one or more features associated with the AP.

13. The AP of claim 9, wherein the short indicator includes a one bit indicator set to 1 to indicate support for the UHR capabilities.

14. The AP of claim 9, wherein based on the beacon frame including the periodic transmission information of the UHR capabilities, the instructions that, when executed by the at least one processor individually or collectively, cause the AP to transmit information associated with dynamic periodic time interval for transmitting the one or more second UHR capabilities in a Beacon UHR frame.

15. The AP of claim 9, wherein based on the beacon frame including the short information, the instructions that, when executed by the at least one processor individually or collectively, cause the AP to: include a link information in the beacon frame for transmitting the one or more second UHR capabilities using a specified communication link between the AP and the at least one UHR capable user device, wherein the specified communication link is different than a communication link used for transmitting the beacon frame.

16. The AP of claim 9, wherein based on the beacon frame including the short indicator, the instructions that, when executed by the at least one processor individually or collectively, cause the AP to include a non-primary channel information in the beacon frame for transmitting the one or more second UHR capabilities.

17. The AP of claim 9, wherein based on the beacon frame including the short information, the instructions that, when executed by the at least one processor individually or collectively, cause the AP to include a version information of the one or more second UHR capabilities in the beacon frame to identify updates of the one or more second UHR capabilities.

18. The AP of claim 9, wherein the instructions that, when executed by the at least one processor individually or collectively, cause the AP to:
receive, from the at least one UHR capable user device, an additional request indicating an identification information of a target AP;
receive, from the target AP, one or more third UHR capabilities associated with the target AP; and
transmit, to the at least one UHR capable user device, the one or more third UHR capabilities associated with the target AP.

19. The AP of claim 9, wherein the instructions that, when executed by the at least one processor individually or collectively, cause the AP to transmit the one or more second UHR capabilities in the beacon frame upon receiving a request from a number of specified UHR capable user devices.

20. The AP of claim 9, the instructions that, when executed by the at least one processor individually or collectively, cause the AP to:
identify a specified set of UHR capable user devices among the one or more user devices in a Basic Serving Set (BSS) associated with the AP; and
include the one or more second UHR capabilities in a specified beacon frame to support the one or more UHR capable user devices among the specified set of UHR capable user devices upon identification.
